(19) United States
(12) Patent Application Publication
(10) Pub. No.: US 2024/0359143 A1
(43) Pub. Date: Oct. 31, 2024

(54) ZWITTERION-PROMOTED HYBRID 2D SILICATE-BASED MEMBRANES FOR ENERGY APPLICATIONS

(71) Applicant: University of Central Florida Research Foundation, Inc., Orlando, FL (US)

(72) Inventors: Kausik Mukhopadhyay, Orlando, FL (US); Suvash Ghimire, Orlando, FL (US)

(21) Appl. No.: 18/647,305

(22) Filed: Apr. 26, 2024

Related U.S. Application Data
(60) Provisional application No. 63/498,604, filed on Apr. 27, 2023.

(51) Int. Cl. B01D 71/02; B01D 69/02; B01D 69/12

(52) U.S. Cl. CPC B01D 71/024; B01D 69/02; B01D 69/125; B01D 2323/46; B01D 2325/26; B01D 2325/42; B01D 2325/54

(57) ABSTRACT

Described herein relates to apparatus and method for developing a free-standing zwitterion-promoted hybrid clay film having excellent ionic conductivity, thermal stability, and/or chemical stability. As such, in an embodiment the clay film apparatus may comprise biocompatible materials, including but not limited to clay and trimethyl glycine (hereinafter “TMG”), also known as a zwitterion. Additionally, in an embodiment, the clay film apparatus may be synthesized utilizing a simple method for making a free-standing flexible, non-polymeric clay film. Moreover, in an embodiment, the prepared film's increased porosity, superior thermal and chemical stability, electrically insulating, and ionic conductivity, as compared to clay films known in the art, may make it an excellent material for energy applications as an ion-conducting membrane. The applications may include but are not limited to battery separators, electrolyte membranes in fuel cells, and solid electrolyte membranes in batteries.

### CROSS-REFERENCE TO RELATED APPLICATIONS

This Nonprovisional Patent Application claims priority to U.S. Provisional Patent Application No. 63/498,604 entitled “ZWITTERION-PROMOTED HYBRID 2D SILICATE-BASED MEMBRANES FOR ENERGY APPLICATIONS” filed Apr. 27, 2023 by the same inventors, all of which is incorporated herein by reference, in its entirety, for all purposes.

### BACKGROUND OF THE INVENTION

### 1. Field of the Invention

This invention relates, generally, to renewable energy. More specifically, it relates to an apparatus and method for developing a free-standing zwitterion-promoted hybrid clay film having excellent ionic conductivity, thermal stability, and/or chemical stability.

### 2. Brief Description of the Prior Art

The world's rising energy needs and reliance on fossil fuels result in significant environmental damage. As a result, numerous efforts have been made to generate clean and sustainable forms of energy, including using tidal, wind, and solar power. However, it is challenging to replace reliance on fossil fuels due to the high cost and seasonal issues associated with these form of alternative energy. Therefore, it is critical to develop alternative energy sources that help fulfill the energy demand and minimize fossil fuel dependency, while also maintaining affordability.

Specifically, looking at ion-conducting members, one of the critical issues that producers of energy storage devices are currently facing is the development of new, unique materials that are feasible, accessible, affordable, and sustainable, along with the desired properties. In order to be effective as a replacement for fossil fuels, the membranes within these energy storage devices must have extremely efficient and effective ion conductivity and chemical stability. Furthermore, the mechanical properties, thermal properties, dimensional stability, and cost are equally crucial for the practical application of ion-conducting membranes. As such, clay-based materials could be one of the potential materials that meet most of these parameters.

Clay minerals are phyllosilicate, composed of a silica tetrahedral (T) sheet and alumina octahedral (O) sheet. The tetrahedral sheets consist of a Si⁴⁺ central cation coordinated with four oxygens; however, the octahedral sheet is Al³⁺ central cation coordinated with six oxygens. Sometimes, in the octahedral sheets the central cation is replaced with other metal atoms also, for instance, Mg²⁺ or Fe²⁺. These sheets join together in certain proportion to form various clay structures such as in 1:1 (T-O) or 2:1 (T-O-T) ratio to form kaolinite and pyrophyllite, respectively. Interestingly, the arrangement of these sheets also defines the morphology ranging from sheets, nanorods to nanotubes. In above structures and morphologies, the montmorillonite (MMT) and bentonite are notable laminar aluminosilicate with T-O-T structure. The anisometric and facile delamination to individual nanosheets have wide range of applications.

Bentonite clay, which primarily consists of MMT, and other minerals such as mica, cristobalite, pyrites, and quartz, has a framework composed of negatively charged clay layers separated by >1 nm, with exchangeable cations held within their interlayer spacing. These properties of bentonite clay, makes it a suitable material for various application, as the exchangeable cations can be substituted with other cations and organic molecules.

Accordingly, what is needed is safe, efficient, and easy-to-use apparatus and method for developing a free-standing hybrid clay film having excellent ionic conductivity and chemical stability. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to an apparatus and method for developing a free-standing zwitterion-promoted hybrid clay film having excellent ionic conductivity, thermal stability, and/or chemical stability.

As stated above, an aspect of the present disclosure pertains to a zwitterion-promoted clay film apparatus. In an embodiment the zwitterion-promoted clay film apparatus may comprise the following: (a) at least one zwitterion molecule; and (b) at least one bentonite clay molecule. In this embodiment, the at least one bentonite clay molecule may comprise at least one clay layer. Additionally, in this embodiment, the at least one zwitterion molecule may be intercalated within at least one portion of the clay layer.

In some embodiments, the at least one clay layer may comprise at least one clay gallery. As such, the at least one zwitterion molecule may be chemically disposed within at least one portion of the at least one clay gallery, such that at least one zwitterion moiety may be formed. In these other embodiments, the at least one zwitterion moiety may comprise a high-carbon derivative of the at least one zwitterion molecule and/or a low-carbon derivative of the at least one zwitterion molecule. In this manner, the at least one clay layer may be smooth and/or distorted. Furthermore, in these other embodiments, the at least one zwitterion moiety may comprise a d-spacing of about 1.4 nm to about 2.2 nm. In addition, the at least one zwitterion moiety may comprise an ionic conductivity. In these other embodiments, the ionic conductivity of the at least one zwitterion moiety may be about 10⁻⁴ S/cm to about 10⁻⁵ S/cm.

In some embodiments, the at least one zwitterion moiety may be thermally stable and/or mechanically stable. In these other embodiments, the at least one zwitterion moiety may be configured to maintain its formation in a temperature of about 250° C. In this manner, the at least one zwitterion moiety may also be configured to maintain its formation when placed within strong solvents, the strong solvents selected from a group consisting of tetrahydrofuran (hereinafter “THF”), hexane, acetonitrile, toluene, dichloromethane (hereinafter “DCM”), and/or a combination of thereof. Additionally, in these other embodiments, the at least one zwitterion moiety may be decomposable in an aqueous solution.

Moreover, another aspect of the present disclosure pertains to a method of synthesizing a zwitterion-promoted clay film apparatus. In an embodiment, the method may comprise the following steps: (a) pretreating at least one zwitterion molecule, the at least one zwitterion having a predetermined carbon chain length; (b) intercalating the at least one zwitterion molecule within at least one portion of at least one bentonite clay molecule having at least one clay layer, the at least one clay layer comprising at least one clay galley; and (c) chemically bonding the at least one zwitterion molecule with at least one portion of the at least one clay galley to form at least one zwitterion moiety.

In some embodiments, the method may further comprise the step of, after chemically bonding the at least one zwitterion molecule with at least one portion of the at least one clay galley, coating the at least one zwitterion moiety upon at least one substrate. In this manner, the method may also comprise the step of, after coating the at least one zwitterion moiety upon the at least one substrate, subsequent to a predetermined drying time, peeling the dried at least one zwitterion moiety off the at least one substrate. In these other embodiments, the predetermined drying time may be about 12 hours. Additionally, the at least one zwitterion moiety may be dried at a temperature of about 60° C.

In some embodiments, the at least one zwitterion moiety may comprise an ionic conductivity. As such, the at least one zwitterion moiety may be thermally stable and/or mechanically stable. In these other embodiments, the at least one zwitterion moiety may be configured to maintain its formation when placed within strong solvents, the strong solvents selected from a group consisting of tetrahydrofuran (hereinafter “THF”), hexane, acetonitrile, toluene, dichloromethane (hereinafter “DCM”), and/or a combination of thereof.

As such, in some embodiments, in order to alter the interlayer spacing of the clay minerals, at least one clay material may be configured to be functionalized with at least one trimethyl glycine (hereinafter “TMG”), better known as a zwitterion. In this manner, zwitterions may be intercalated into a clay gallery comprising the at least one clay material, such that the interlayer gap of the at least one clay material may be configured to widen.

Additionally, in some embodiments, at least one bentonite layer of the clay film apparatus may be configured to be intercalated with at least one zwitterion and/or at least one higher carbon derivative of the at least one zwitterion. As such, in these other embodiments, the higher chain derivatives may be configured to distort the at least one bentonite layer, such that a non-smooth stacked free-standing clay apparatus may be formed. In some embodiments, the at least one bentonite layer of the clay film apparatus may comprise at least one lower chain derivative of the at least one zwitterion, such that the at least one bentonite layer formed a smooth stacked free-standing film.

In some embodiments, a d-spacing value of the clay film apparatus may comprise a range of about 1.00 nm to about 2.10 nm in the pristine to zwitterion clay composite. For example, in some embodiments, the d-spacing value of the clay film apparatus may be about 1.5 nm to about 1.91 nm in the pristine to zwitterion clay composite. As such, in these other embodiments, the clay film apparatus may be thermally and/or mechanically stable, such that the clay film apparatus may be easily decomposable in water. In this manner, the clay film apparatus may comprise a substantial ionic conductivity of bentonite clay membrane due to the at least one functionalized lower carbon chain zwitterion.

In addition, in some embodiments, at least one clay layer may be fused with the aid of the at least one zwitterion, such that the at least one fused clay layer may be configured to create a flexible free-standing clay film and/or membrane apparatus. As such, in these other embodiments, the zwitterion's carbon chain may also be configured to increase, and/or its effects on the clay's interlayer spacing have been investigated.

Moreover, in these other embodiments, the clay film apparatus may be functionalized with at least one lower carbon chain length zwitterion, such that the clay film apparatus may comprise a pseudo-trilayer arrangement of the at least one lower carbon chain zwitterion within the at least one clay layer of the clay film apparatus. However, in some embodiments, the at least one zwitterion comprising at least one longer carbon chain may be configured to form at least one monolayer and/or the at least one zwitterion may have smaller interlayer spacings as compared to a hybrid clay films functionalized with lower carbon chain zwitterions. As known in the art, the functionalized hybrid clay films may be characterized using x-ray photoelectron spectroscopy, scanning electron microscopy, and/or x-ray fluorescence techniques to explore the films' structural and morphological parameters.

Furthermore, in some embodiments, the ionic conductivity of the functionalized clay film may be investigated in a non-aqueous electrolyte. In this manner, the functionalized clay film apparatus may be comparable to some of the polymer membrane, such that the clay film apparatus may be used as ion-conducting membranes in energy applications such as battery separators, electrolyte membranes in fuel cells, and/or solid electrolyte membranes in batteries.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graphical illustration illustrating a possible arrangement of at least one zwitterion in a clay gallery of a clay film, according to an embodiment of the present disclosure.

FIG. 2 is a plot illustrating an X-ray diffraction analysis of a clay film apparatus, according to an embodiment of the present disclosure.

FIG. 3 is a plot illustrating an ATR-FTIR of zwitterion, bentonite, and a clay film apparatus, according to an embodiment of the present disclosure.

FIG. 4 is a plot illustrating an XPS survey spectrum of bentonite clay and a clay film apparatus, according to an embodiment of the present disclosure.

FIG. 5 is a plot illustrating a thermal stability of bentonite, zwitterion, and a clay film apparatus, according to an embodiment of the present disclosure.

FIG. 6A is a Nyquist plot for a BB1-CF clay membrane, according to an embodiment of the present disclosure.

FIG. 6B is a Nyquist plot for a BB3-CF clay membrane, according to an embodiment of the present disclosure.

FIG. 6C is a Nyquist plot for a BB5-CF clay membrane, according to an embodiment of the present disclosure.

FIG. 7 is a XRD analysis of BB1-CF sample under varying electrolyte concentration, according to an embodiment of the present disclosure.

FIG. 8 is a bar graph depicting an electrolyte uptake of BB1-CF sample under various electrolyte concentrations, according to an embodiment of the present disclosure.

FIG. 9 is a thermogravimetric analysis (hereinafter “TGA”) of BB1-CF membrane dipped in varied electrolyte concentrations, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

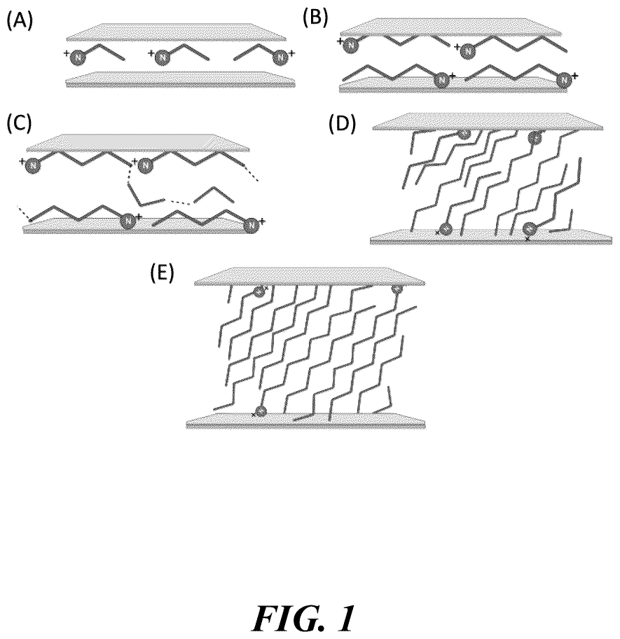

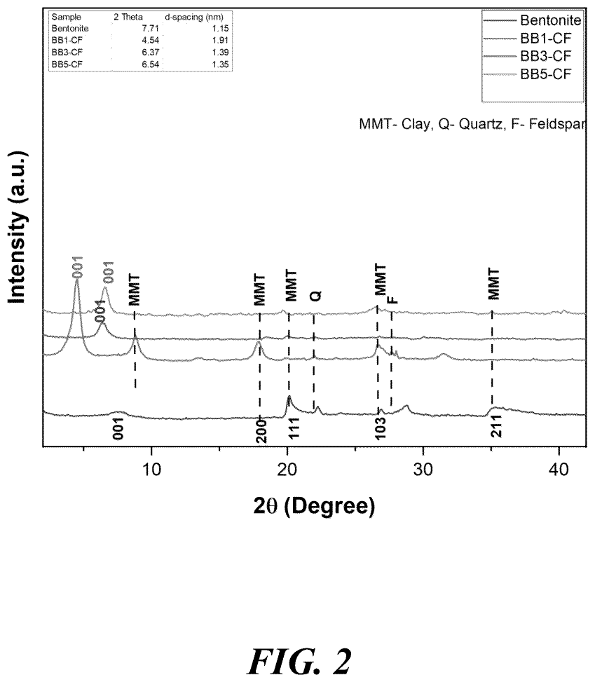

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

As used herein, the terms “about,” “approximately,” or “roughly” as used herein refer to being within an acceptable error range for the particular value as determined by one of ordinary skill in the art, which will depend in part on how the value is measured or determined (i.e., the limitations of a measurement system), (i.e., the degree of precision required for a particular purpose, such as developing a free-standing zwitterion-promoted hybrid clay film having excellent ionic conductivity and/or chemical stability).

As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Zwitterion-Promoted Clay Film Apparatus

The present disclosure pertains to apparatus and method for developing a free-standing zwitterion-promoted hybrid clay film and/or membrane (hereinafter “clay film apparatus”) having excellent ionic conductivity and chemical stability. In an embodiment, the clay film apparatus may have a composition comprising of clay, water, and/or at least one zwitterion (i.e., Trimethyl glycine (hereinafter “TMG”); commonly referred to as betaine), such that the clay film apparatus may be configured to be used for different applications.

In an embodiment, the at least one zwitterion may be synthesized by first disposing at least one aliphatic acid molecule, at least one bromide molecule and/or acetonitrile molecule within an enclosed environment (e.g., a flask), such that the at least one aliphatic acid molecule, the at least one bromide molecule, and/or the at least one acetonitrile molecule may be mixed, creating a mixed acidic solution. As such, in some embodiments, the mixed acidic solution may be mixed via a centrifuge, such that the acidic solution may be mixed at a predetermined acid mixing speed (e.g., at least 2 mm/s) for a predetermined amount of time (e.g., at least 50 min.). In this manner, next, in an embodiment, the at least one trimethylamine molecule disposed within an acidic solution (e.g., ethanol) may be poured and/or disposed within the mixed acid solution, such that the mixed acid solution comprising the at least one trimethylamine molecule may be stirred and/or mixed at a predetermined speed (e.g., at least 2 mm/s) for a predetermined period of time (e.g., at least 30 min.) After adequate mixing, in this embodiment, the mixed acidic solution comprising the at least one trimethylamine molecule may be configured to be concentrated under reduced pressure, such that the mixed acidic solution may then be filtered. As such, once the filtering has been completed, the mixed acidic solution may then be dried at a predetermined temperature for a predetermined amount of time, such that at least one solid zwitterion (i.e., at least one betaine salt) may be obtained. Accordingly, in some embodiments, a carbon chain length of the at least one zwitterion (i.e., the at least one betaine salt) may be increased and/or decreased. In this manner, in these other embodiments, the increase and/or decrease of the carbon chain length of the at least one zwitterion may affect the interlayer spacing of the at least one zwitterion within the clay film apparatus.

In this manner, in an embodiment, the clay film apparatus may then be synthesized by first preparing at least one clay material in water (e.g., deionized water), such that a clay slurry may be formed. Next, the clay slurry may be spun (e.g., centrifugation) at a predetermined speed (e.g., at least 2 mm/s) for a predetermined amount of spinning time (e.g., at least 6 hrs.), such that the at least one solid zwitterion (i.e., the at least one betaine salt) may be intercalated within the at least one clay material. As such, in this embodiment, the intercalated clay slurry may then be coated on at least one substrate (e.g., glass) and/or dried by any manner known in the art for a predetermined drying time (e.g., at least 12 hrs.) at a predetermined temperature (e.g., at least 60° C.). Moreover, once the clay slurry has dried, the clay slurry may then be peeled off the substrate, such that the clay film apparatus may be obtained.

FIG. 1 depicts possible arrangements of zwitterions within a clay gallery of the clay film apparatus, according to an embodiment of the present disclosure. As such, in an embodiment, the intercalation of zwitterions and/or any change within the clay gallery of the clay film apparatus within the d-spacing and/or the interlayer spacing of the clay film apparatus may be verified by measuring the change in the d001 diffraction peak of the clay within the clay film apparatus. In this manner, in an embodiment, the change in the d-spacing of clay may be associated with the arrangements of zwitterions in the clay gallery of the clay film apparatus.

Additionally, as shown in FIG. 2, in conjunction with FIG. 1, in an embodiment, the monolayers, bilayers, pseudo-trimolecular layers, and/or paraffin-type arrangements inside the clay gallery of the clay film apparatus may correspond to the d-spacing comprising a range of about 1.0 to about 10.0 nm. For example, in some embodiments, the monolayers, bilayers, pseudo-trimolecular layers, and/or paraffin-type arrangements inside the clay gallery of the clay film apparatus may correspond to the d-spacing of about 1.4 nm, about 1.8 nm, about 1.8 to about 2.2 nm, and/or at least 2.2 nm, respectively. Additionally, in some embodiments, for example, the functionalized clay film apparatus may be prepared with lower carbon chain zwitterion having a d-spacing of about 1.91 nm, suggesting the pseudo-trimolecular arrangements of zwitterion may be disposed within the clay gallery of the clay film apparatus. Moreover, in some other embodiments, for example, the functionalized clay film apparatus prepared with higher carbon chain zwitterion showed a d-spacing of about 1.4 nm, suggesting monolayer arrangements.

In addition, in an embodiment, the clay film apparatus may comprise ionic conductivity in a non-aqueous scenario. For example, the clay film apparatus may be tested for ionic conductivity in a non-aqueous electrolyte system using EIS (electrochemical impedance spectroscopy) technique. In this manner, the clay film apparatus may be soaked in an electrolyte for some time, and then carried out the EIS measurement. The ionic conductivity of the electrolyte-soaked membrane may be calculated using the equation, as provided below:

$$σ = d / ( A \times {R}_{b} ) \qquad ( 1 )$$

Where “σ” may represent the ionic conductivity, “A” and “d” may represent the membrane's area and thickness, and the bulk resistance is obtained from the high-frequency intercept of the impedance. As such, in an embodiment, the clay film apparatus may comprise an ionic conductivity having a range of about 10⁻⁴ S/cm to about 10⁻⁵ S/cm. The obtained ionic conductivity of the clay film apparatus may be better compared to the ionic conductivity of ion-conducting membranes used as a battery separator, solid-state electrolyte membranes, and/or polymer electrolyte membranes in a fuel cell.

Moreover, in an embodiment, the prepared clay film apparatus may be tested for chemical and/or thermal stability. In this manner, the clay film apparatus may withstand the temperature of at least 250° C. and/or the clay film apparatus may be configured to maintain its formation when placed within strong solvents, including but not limited to tetrahydrofuran (hereinafter “THF”), hexane, acetonitrile, toluene, dichloromethane (hereinafter “DCM”). In some embodiments, due to its significant chemical and/or thermal stability, the clay film apparatus may be used as an antimicrobial patch in wound healing applications.

As known in the art, gas separation technology uses a membrane that allows the selective gas molecule to pass through while blocking the other gases. The demand of gas separation technology has been increasing rapidly with an annual growth rate of about 8% to about 10% per year. As such, in chemical and petrochemical refining industries the gas separation technology account for about 45% of all process energy used. Utilizing the clay film apparatus in gas separation may offer a several advantages over traditional methods, including low cost, simpler technology, small size, and/or efficiency. This is because, as known in the art, the most used and/or commercially available membranes for gas separation process are polymeric materials such as polyamides, polysulfones, polyurethanes, nafion, etc.

In this manner, in an embodiment, the clay film apparatus may be configured to separate at least one gas from at least one alternative gas as a plurality of gas translates through the clay film apparatus. Accordingly, the developed clay film apparatus may comprise at least one important property of the gas separation membrane. In this embodiment, at least one zwitterion (i.e., betaine) in the membrane may be configured to create a charge-balance and/or may be configured to aid in reducing at least one defect of the clay film apparatus. Moreover, in this embodiment, the zwitterion formation of the clay film apparatus may allow the clay film apparatus to comprise at least one of the following, a high permeability, an improved selectivity, and/or an excellent stability, such that the clay film apparatus may be configured to optimize gas separation process.

Furthermore, as known in the art, global warming and/or climate change are two of the most critical issues the world is currently facing. The main reason of climate change is the increasing concentration of carbon dioxide. As such, there is an immediate need to develop “carbon neutral” technology. This carbon neutrality can be achieved by reducing the carbon emission at source and capturing and storing the emitted CO₂.

As such, in an embodiment, the clay film apparatus may be configured to absorb at least one portion of a CO₂ gas. In this manner, the clay film apparatus may comprise a high specific surface area and/or an exceptional adsorption capacity. The adsorption capacity of clay minerals make it a very suitable material for low-cost CO₂ capture. In this embodiment, the clay film apparatus may be configured to interact with the CO₂, such that the clay film apparatus may be configured to trap the at least one portion of the CO₂ gas on at least a portion of its surface and/or as within at least one portion of the at least one interlayer space of the clay film apparatus as the at least one portion of the CO₂ gas traverses and/or translates through the clay film apparatus.

The following example(s) is (are) provided for the purpose of exemplification and is (are) not intended to be limiting.

### EXAMPLES

### Example 1

### Zwitterion-Promoted Clay Film Apparatus

Bentonite clay films were synthesized, allowing the clay film surface, structural, mechanical and ionic properties to be explored and/or examined. The bentonite layers were intercalated with at least one zwitterion and higher carbon derivative of the zwitterion. Interestingly, the lower chain derivative formed smooth stacked free-standing film, however, the higher chain derivatives showed distorted layers. The intercalation of zwitterion moiety in clay gallery and concomitantly the change in the d-spacing has been explored through powder diffraction X-ray analysis. The d-spacing value varied from 1.15 nm to 1.91 nm in the pristine to zwitterion clay composite. The structural and morphological aspects of these films have been explored though the scanning electron microscopy, infrared (hereinafter “IR”) spectroscopy, thermogravimetric analysis (hereinafter “TGA”), and x-ray photoelectron spectroscopy (hereinafter “XPS”) studies. The clay film apparatuses are thermally and/or mechanically stable, however, easily decomposable in water. Additionally, the clay films have been demonstrated to have remarkable ionic conductivity of bentonite clay membrane functionalized with lower carbon chain zwitterion.

### Zwitterion Synthesis

To synthesize a zwitterion, the aliphatic acid bromide and acetonitrile were added to a round bottom flask and mixed. Then, the solution of 4.2 M trimethylamine (e.g., 1.5 eq) in ethanol is added to the acid solution and stirred for sufficient period of time. After adequate stirring, the solution was concentrated under reduced pressure, and then filtered. The filtered solids were ringed with acetone and hexane. The white solid powder dried to obtain the zwitterion salts. The different precursor of zwitterions is confirmed by ¹H NMR analysis. The synthesized zwitterion (i.e., betaine) precursors and their respective structures are shown in TABLE 1, as provided below.

### Bentonite-Zwitterion Clay Films (i.e., BB-CFs) Synthesis

In preparation of Bentonite/Zwitterion Clay Film, 3.3 g of bentonite clay was dispersed in excess deionized water (e.g., DI water). The mixture was kept for shaking for 12 h followed by centrifugation. The supernatant was discarded, and residue was washed 3-4 times with DI water. Finally, 0.578 g of zwitterion (C1) and 10 mL of DI water was added to the residue and kept for shaking for 12 h. As such prepared slurry was coated over glass plate using coating machine. The speed of the film coater was 2 mm/s. The coated glass plates were kept for drying in the oven at 60° C. for 12 h. After drying, the film was peeled from the glass plate and designated as Bentonite/Zwitterion Clay Film (BB1-CF).

For the preparation of higher carbon derivative of Bentonite/Zwitterion Clay Films similar procedure were followed. A C3 and a C5 derivative of a zwitterion (i.e., a different length of carbon chains) were used in the elementary steps for the formation of BB3-CF and BB5-CF respectively.

### Characterization

The Powder X-Ray Diffraction (hereinafter “PXRD”) pattern was recorded with PAN Analytical instrument operated at 45 kV generator voltage and 40 A tube current. As such, the instrument was equipped with Cu anode material, generating K-Alpha (1.540 nm) and K-Alpha2 (1.544 nm). Fixed divergent silt of 0.4 mm without any monochromator and 0.5 ratio of K-Alpha2/K-Alpha was used during data collection. The patterns were collected from 2° 2-theta value to 420 value. For infrared spectroscopy (IR) Cary 630 FTIR Spectrometer with ATR sampling module was employed. The spectra was collected from 450 cm⁻¹ to 4000 cm⁻¹ with the step size of 4 cm⁻¹. The X-Ray Photoelectron Spectra (hereinafter “XPS”) of the samples were then obtained. The instrument utilized to collect the XPS was equipped with Al K-Alpha (1486.7 eV; 0.833 nm) source gun. During data collection the spot size was 650 m and pass energy for analyzer was 150 eV. In the analysis 1.0 eV was step size for survey spectra and 0.1 eV for high resolution spectra. XPS Avantage software was used for the deconvolution of the high-resolution spectra. The impedance spectra of the Clay Films was collected over CHI 700E series potentiostat. The frequency varied from 1 MHz to 0.1 mHz during the data collection.

### Results and Discussion

To explore the intrinsic structural changes in the clay films, the diffraction patterns of the films/membranes were collected. FIG. 2 depicts the XRD pattern of the pristine bentonite clay and composite films with zwitterion derivatives. The peaks at 18.6°, 20.2°, 27.8°, and 350 corresponds to the (200), (111), (103), and (211) MMT planes respectively. In addition to MMT peaks, there are Feldspar and Quartz peaks in the bentonite and hybrid clay films. The 001 peaks in bentonite clay appeared at 7.710 which corresponds to the 1.14 nm, which moved toward lower 2theta value increasing the d-spacing value to 1.91 nm, 1.39 nm and 1.35 nm in hybrid clay films BB1-CF, BB3-CF, and BB5-CF respectively. The shift in (001) plane indicates the alteration in the interlayer spacing of the clay due to the zwitterion intercalation. The highest d-spacing found in BB-1 and it decreased with higher zwitterion derivative films. The reason for changing the d-spacing in zwitterion modified clay membranes is because of the different orientation of zwitterion molecules inside the clay gallery. As such, the lower carbon chain zwitterion molecule are configured to make a pseudo-trilayer structure exhibits higher d-spacing, and the higher carbon chain zwitterion molecules are oriented in a way that imparts a monolayer distribution, thereby, exhibiting a lower d-spacing compared to shorter carbon chain zwitterion.

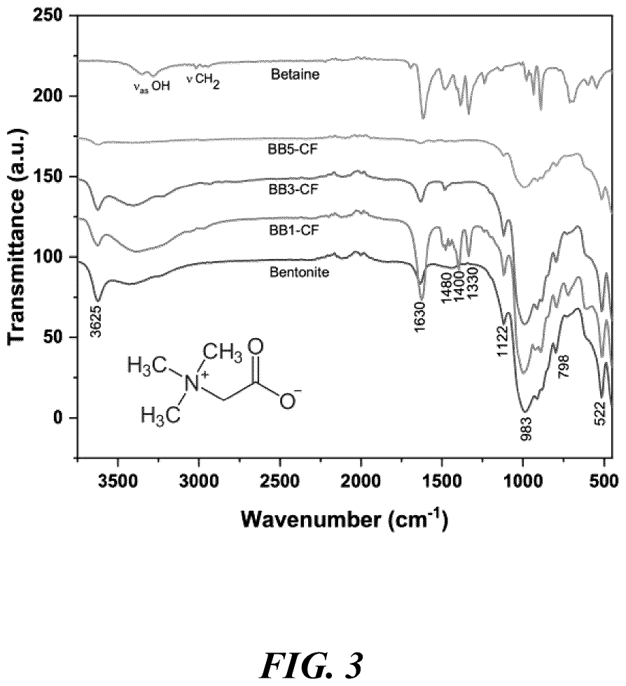

To explore the detailed structural aspects, infrared spectroscopy, as shown in FIG. 3. The infrared spectra of the composite films show prominent peaks at 3625 cm⁻¹, 1630 cm⁻¹, 1480 cm⁻¹, 1400 cm⁻¹, 1330 cm⁻¹, 983 cm⁻¹, 798 cm⁻¹, and 522 cm⁻¹. The peak at 3625 cm⁻¹ corresponds to OH— stretching vibration of the interlayer water. The peak at 1630 cm⁻¹ is for intercalated H—O—H bending which overlay with the vibrations of asymmetric COO— bending from zwitterion molecules. However, the peaks intensity increased in the zwitterion intercalated clay films. The other distinct peak from zwitterion molecule appeared at 1480 cm⁻¹ which ascribed to symmetric COO— bending. The characteristic stretching peaks of Si—O and Al—OH are present at 983 cm⁻¹ and 522 cm⁻¹, respectively. This suggests the successful intercalation of zwitterion molecules in bentonite clay.

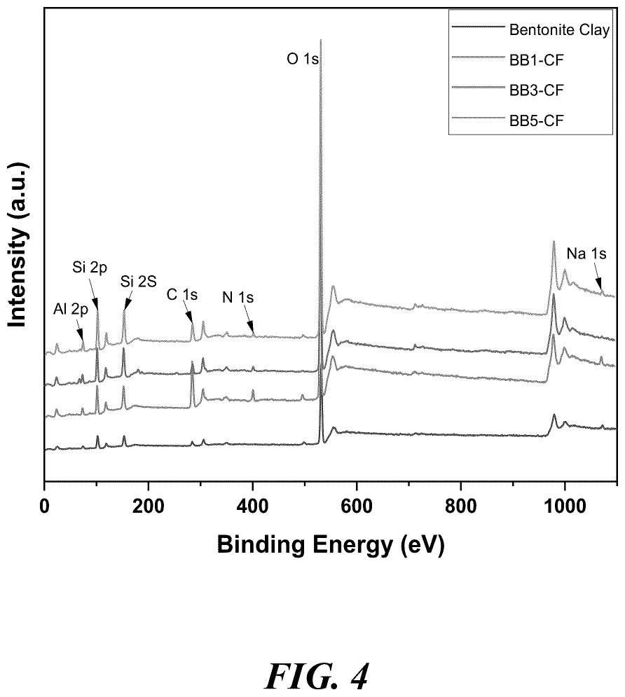

In addition to the ATR-FTIR, the synthesized clay membranes were characterized using XPS. Survey spectrum of the pristine bentonite clay shows Al 2p, Si 2p, Si 2s, C Is, O Is, and Na is peaks, these peaks are in the coherence with the composition of bentonite clay. However, the new N is peak in the synthesized clay membrane confirms the presence of the zwitterion molecule in the membranes. The atomic percentage of nitrogen is provided in TABLE 2, provided below, and depicted in FIG. 4, as provided below.

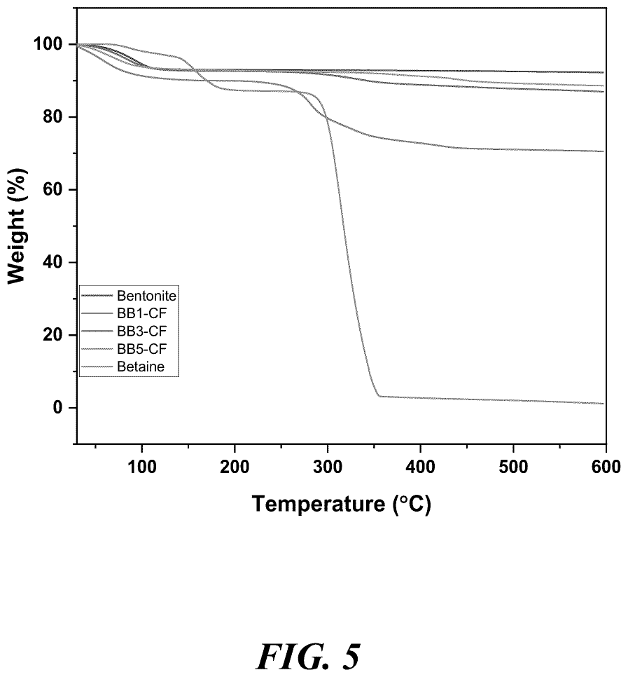

Thermogravimetric analysis (hereinafter “TGA”) used to assess the thermal stability (e.g., melting, and subsequent degradation) of composite clay films. As such, FIG. 5 depicts the TGA curves of bentonite clay and composite clay membrane in N₂ environment. The pure bentonite clay shows a marked weight loss at ˜105° C. (9% weight loss), suggesting the dehydration of clay. Dehydration occurs in clay at lower temperatures mainly due to water loss from clay's external and internal structure. The amount of water absorbed in clay is primarily associated with cations occupying the exchangeable site between clay layers or cation solvation shells. The moisture absorbed on the surface is released in the dehydration process, followed by the water molecule bound to the exchangeable cations.

The zwitterion molecule shows three decomposition steps. Initial smooth weight loss owing to moisture evaporation at 100° C., followed by significant weight loss (e.g., comprising of 90%) due to pyrolysis in the 285-345° C. range, followed by smoother degradation at higher temperatures, when the remaining material turns to carbon residue. It is observed that after dehydration, there is negligible weight loss between 105 and 500° C. for pure bentonite clay; however, considerable weight loss is seen in composite clay films in the range 245-340° C. followed by smooth weight loss up to 500° C. This suggested that the organic zwitterion in bentonite-zwitterion films has been pyrolyzed and decomposed after the samples were heated to 500° C. TGA analysis suggested the thermal stability of synthesized clay films up to ˜250° C.

### Ionic Conductivity of Zwitterion Modified Composite Clay Membranes (BB-CFs)

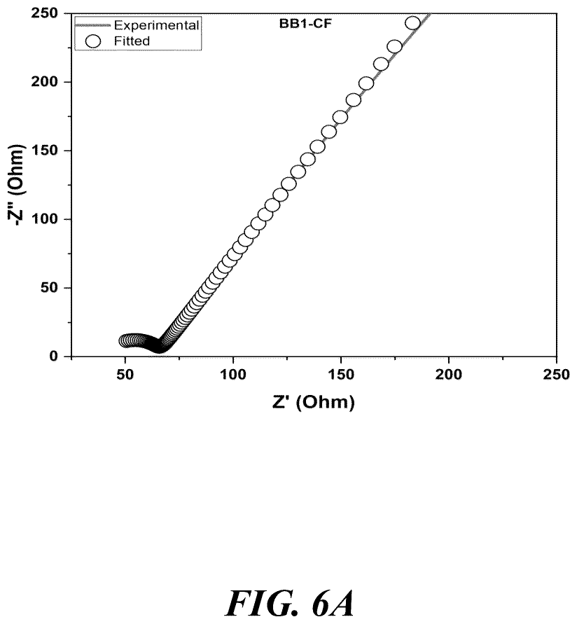

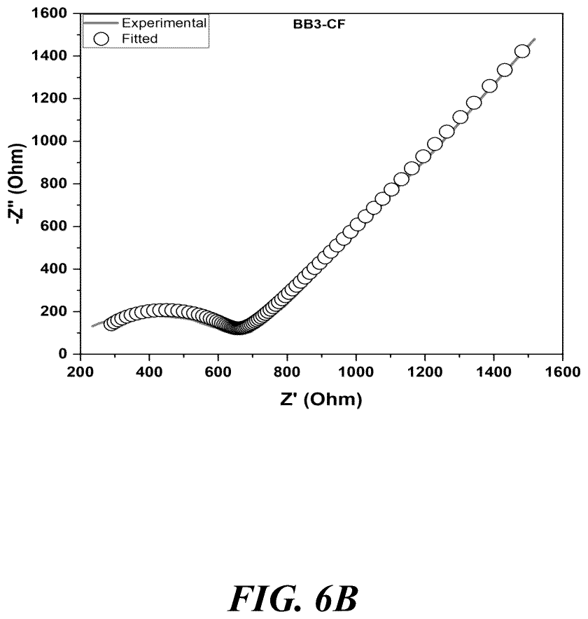

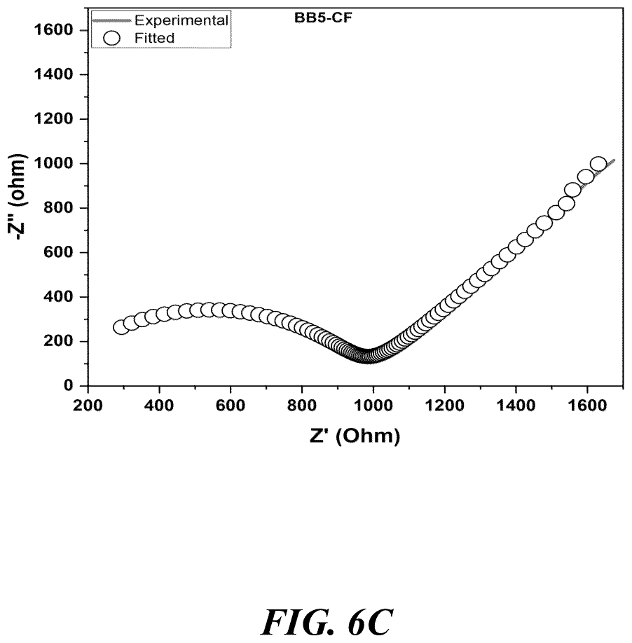

The electrochemical impedance of the zwitterion intercalated zwitterion clay films at room temperature was also investigated. The ionic conductivity of the hybrid clay membranes was calculated by considering the film thickness, the electrode area, and the impedance using the equation, as provided in the above description, and provided, once again, below:

$${σ}_{i} = d / {R}_{b} \times A \qquad ( 1 )$$

Where d is the membrane thickness, R_{b} is the bulk resistance obtained from the intercept of the curve with the real impedance axis, and A is the contact area of the membrane and the electrode. FIGS. 6A-6C depict the Nyquist plots for BB1-CF, BB3-CF, and BB5-CF and the corresponding ionic conductivity calculated using Eq (1) is shown in TABLE 3, as provided below.

### CONCLUSION

The electronically insulating and/or ionically conducting membrane is a promising material in energy storage devices where it can be used as a battery separator in batteries, electrolyte membrane in fuel cell, solid state electrolyte membrane in lithium ion and sodium ion batteries. Herein, a non-polymeric clay-based membrane (i.e., the clay film apparatus) was developed using environmentally benign intercalating material (i.e., a zwitterion). The fabricated membranes showed high thermal and mechanical stability. The ionic conductivity of the fabricated membrane has potential applications as ion conducting membrane in energy storage devices. In addition, the cost effectiveness, easy synthesis procedure, and environmentally friendly nature make it a potential ion-conducting membrane in energy storage devices with further optimization.

TABLE 1

| Betaine (i.e., Zwitterion) | Chemical Structure |
|---|---|
| C1-betaine | 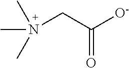 |
| C2-betaine | 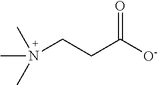 |
| C3-betaine | 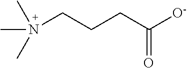 |
| C4-betaine | 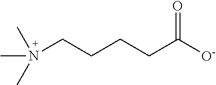 |
| C5-betaine | 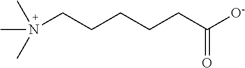 |

TABLE 2

| Sample | Element | B.E. (eV) | Atomic % |
|---|---|---|---|
| Bentonite | N 1s | — | — |
| BB1-CF | N 1s | 401.3 | 4.2 |
| BB3-CF | N 1s | 401.0 | 2.2 |
| BB5-CF | N 1s | 401.75 | 1.74 |

TABLE 3

| Sample | Thickness | | Area | Bulk Resistance | | Ionic Conductivity |
|---|---|---|---|---|---|---|
| BB1-CF | 58 | μm | 3.14 cm² | 46 | Ω | 0.40 × 10⁻⁴ Scm⁻¹ |
| BB3-CF | 53 | μm | 3.14 cm² | 278 | Ω | 0.61 × 10⁻⁵ Scm⁻¹ |
| BB5-CF | 54 58 | μm | 3.14 cm² | 290 | Ω | 0.59 × 10⁻⁵ Scm⁻¹ |

### Example 2

### Influence of Electrolyte Concentration on the Ionic Conductivity of the Zwitterion-Promoted Clay Film Apparatus

The impact of electrolyte concentrations on the zwitterion-promoted clay film apparatus which has exhibited excellent ionic conductivity was examined. Specifically, the ionic conductivity of the BB1-CF membrane (i.e., the zwitterion-promoted clay film apparatus) at various electrolyte concentrations, including no electrolyte (0M), 0.01M, 0.1 M, and 1 M concentration of LiClO4 in E. C. (ethylene carbonate) and/or DMC. (dimethyl carbonate) (1:1 vol/vol) was reviewed. This examination aids in understanding and/or streamline the mechanism behind ionic conductivity of the zwitterion-promoted clay film apparatus, shedding light on the role of electrolyte concentration in influencing membrane conductivity

### Results:

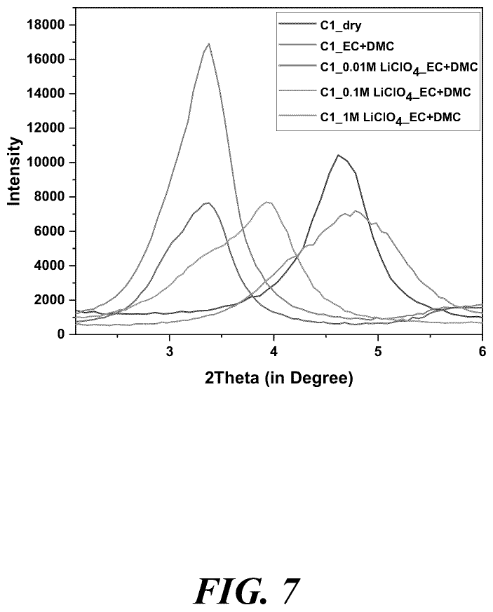

The samples of the zwitterion-promoted clay film apparatus are named as: C1-dry, C1_EC+DMC, C1_0.01M LiClO4_EC+DMC, 0.1M LiClO4_EC+DMC, and C1_1M LiClO4_EC+DMC. In this context, as shown in FIG. 7, the C1_dry sample represents the BB1-CF sample without any electrolyte solution, C1_EC+DMC represents the BB1-CF membrane in EC (ethylene carbonate) and DMC (Dimethyl carbonate), and the samples prefixed with numerals indicate the concentration of LiClO4 in the EC and DMC solution (1:1 vol/vol).

TABLE 4

| Sample | 2Theta | d₀₀₁ |
|---|---|---|
| Bentonite | 7.71 | 1.15 nm |
| C1_dry | 4.6 | 1.92 nm |
| C1_EC + DMC | 3.37 | 2.62 nm |
| C1_0.01M LiClO4_EC + DMC | 3.37 | 2.62 nm |
| C1_0.1M LiClO4_EC + DMC | 3.93 | 2.25 nm |
| C1_1M LiClO4_EC + DMC | 4.78 | 1.85 nm |

As shown in TABLE 4, provided above, the d-spacing of the membrane exhibited a decrease as the electrolyte concentration increased. The interlayer spacing in the membrane is, in part, influenced by the quantity of electrolytes surrounding the cations. A higher number of electrolytes correlates with an increased interlayer spacing. This observation implies that a lower number of electrolyte solutions penetrate the membrane as the concentration rises. The electrolyte uptake test aligns with this finding. Electrolyte uptake is determined using the formula:

$$\% Electrolyte Uptake = \frac{{M}_{w e t} - {M}_{d r y}}{{M}_{d r y}} \qquad ( 2 )$$

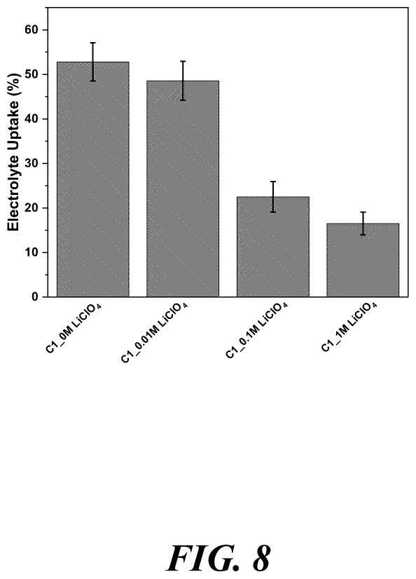

In the above equation, M_{dry} represents the mass of the dry membrane, and/or M_{wet} represents the mass of the membrane soaked in electrolyte solution of different concentrations. Accordingly, as shown in FIG. 8, the electrolyte uptake of the membrane decreases with increasing the electrolyte concentration.

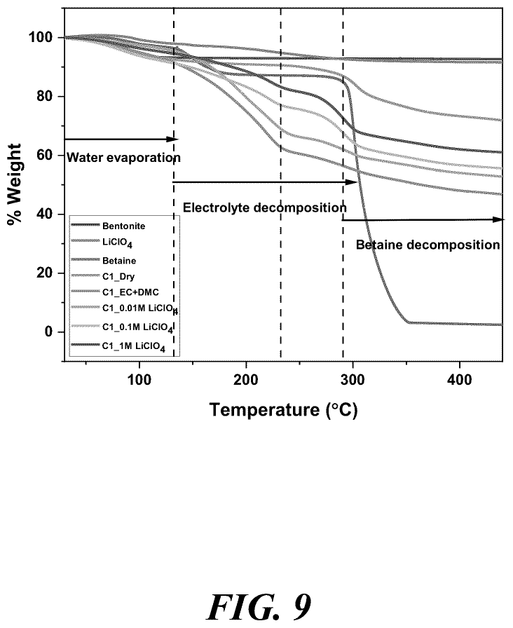

In TGA analysis, as shown in FIG. 9, the initial weight loss indicates water evaporation from the membrane, while the subsequent two weight losses are linked to electrolyte decomposition and zwitterion decomposition, respectively. The higher weight loss observed in samples immersed in less concentrated electrolyte aligns with the results from XRD and the electrolyte uptake experiment.

### Conclusion:

As such, the zwitterion-promoted clay film apparatus demonstrates excellent ionic conductivity in two electrode setup experiment. In addition to the ionic conductivity, the low-cost, radial availability, and/or environmental friendliness of the materials used in the zwitterion-promoted clay film apparatus makes it a suitable material for the applications.

As mentioned above, the primary market opportunities for the zwitterion-promoted clay film apparatus may be to use it as an environmentally friendly, sustainable, and/or non-polymeric membrane for energy application, for example, as battery separators and/or as membranes for separation of ionic and/or non-ionic solutions.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Esser, B.; Dolhem, F.; Becuwe, M.; Poizot, P.; Vlad, A.; Brandell, D. A Perspective on Organic Electrode Materials and Technologies for next Generation Batteries. J Power Sources 2021, 482, 228814. https://doi.org/10.1016/J.JPOWSOUR.2020.228814.
Chen, W.; Lei, T.; L v, W.; Hu, Y.; Yan, Y.; Jiao, Y.; He, W.; Li, Z.; Yan, C.; Xiong, J.; Chen, W.; Lei, T.; L v, W.; Hu, Y.; Yan, Y.; He, W.; Li, Z.; Xiong, J.; Jiao, Y.; Yan, C. COMMUNICATION 1804084 (1 of 8) Atomic Interlamellar Ion Path in High Sulfur Content Lithium-Montmorillonite Host Enables High-Rate and Stable Lithium-Sulfur Battery. 2018. https://doi.org/10.1002/adma.201804084.
Lagaly, G.; Beneke, K. Intercalation and Exchange Reactions of Clay Minerals and Non-Clay Layer Compounds. Colloid Polym Sci 1991, 269 (12), 1198-1211. https://doi.org/10.1007/BF00652529/METRICS.
Lan, Y.; Liu, Y.; Li, J.; Chen, D.; He, G.; Parkin, I. P.; Lan, Y.; Liu, Y.; Li, J.; He, G.; Parkin, I. P.; Chen, D. Natural Clay-Based Materials for Energy Storage and Conversion Applications. Advanced Science 2021, 8 (11), 2004036. https://doi.org/10.1002/ADVS.202004036.
Kim, M.; Kim, J. K.; Park, J. H.; Kim, M.; Kim, J. K.; Park, H. Clay Nanosheets in Skeletons of Controlled Phase Inversion Separators for Thermally Stable Li-Ion Batteries. Adv Funct Mater 2015, 25 (22), 3399-3404. https://doi.org/10.1002/ADFM.201500758.
Ras, R. H. A.; Umemura, Y.; Johnston, C. T.; Yamagishi, A.; Schoonheydt, R. A. Ultrathin Hybrid Films of Clay Mineralsw. https://doi.org/10.1039/b610698f.
Brigatti, M. F.; Galan, E.; Theng, B. K. G. Chapter 2 Structures and Mineralogy of Clay Minerals. Dev Clay Sci 2006, 1 (C), 19-86. https://doi.org/10.1016/51572-4352(05)01002-0.
Wang, Q.; Zhu, C.; Yun, J.; Yang, G. Isomorphic Substitutions in Clay Materials and Adsorption of Metal Ions onto External Surfaces: A DFT Investigation. Journal of Physical Chemistry C 2017, 121 (48), 26722-26732. https://doi.org/10.1021/ACS.JPCC.7B03488/ASSET/IMAGES/LARGE/JP-2017-03488Y_0010.JPEG.
Ewis, D.; Ba-Abbad, M. M.; Benamor, A.; El-Naas, M. H. Adsorption of Organic Water Pollutants by Clays and Clay Minerals Composites: A Comprehensive Review. Appl Clay Sci 2022, 229. https://doi.org/10.1016/J.CLAY.2022.106686.
Mallakpour, S.; Dinari, M. Preparation and Characterization of New Organoclays Using Natural Amino Acids and Cloisite Na+. Appl Clay Sci 2011, 51 (3), 353-359. https://doi.org/10.1016/J.CLAY.2010.12.028.
Du, M.; Liu, J.; Clode, P.; Leong, Y. K. Microstructure and Rheology of Bentonite Slurries Containing Multiple-Charge Phosphate-Based Additives. Appl Clay Sci 2019, 169, 120-128. https://doi.org/10.1016/J.CLAY.2018.12.023.
Zhirong, L.; Azhar Uddin, M.; Zhanxue, S. FT-IR and XRD Analysis of Natural Na-Bentonite and Cu(II)-Loaded Na-Bentonite. Spectrochim Acta A Mol Biomol Spectrosc 2011, 79 (5), 1013-1016. https://doi.org/10.1016/j.saa.2011.04.013.
Lagaly, G. Principles of Flow of Kaolin and Bentonite Dispersions. Appl Clay Sci 1989, 4 (2), 105-123. https://doi.org/10.1016/0169-1317(89)90003-3.
Madejová, J. FTIR Techniques in Clay Mineral Studies.
Viertorinne, M.; Valkonen, J.; Pitkänen, I.; Mathlouthi, M.; Nurmi, J. Crystal and Molecular Structure of Anhydrous Betaine, (CH3)3NCH2CO2. J Mol Struct 1999, 477 (1-3), 23-29. https://doi.org/10.1016/S0022-2860(98)00613-9.
Mallakpour, S.; Dinari, M. Preparation and Characterization of New Organoclays Using Natural Amino Acids and Cloisite Na+. Appl Clay Sci 2011, 51 (3), 353-359. https://doi.org/10.1016/j.clay.2010.12.028.
Lee, S.; Hwang, H. S.; Cho, W.; Jang, D.; Eom, T.; Martin, D. C.; Wie, J.; Shim, B. S. 900134 (1 of 11) Eco-Degradable and Flexible Solid-State Ionic Conductors by Clay-Nanoconfined DMSO Composites. 2020. https://doi.org/10.1002/adsu.201900134.
Kim, J. H. Grand Challenges in Membrane Applications—Gas and Vapor. Frontiers in Membrane Science and Technology 2022, 1, 1. https://doi.org/10.3389/FRMST.2022.853402.
Roy, A.; Venna, S. R.; Rogers, G.; Tang, L.; Fitzgibbons, T. C.; Liu, J.; McCurry, H.; Vickery, D. J.; Flick, D.; Fish, B. Membranes for Olefin-Paraffin Separation: An Industrial Perspective. Proc Natl Acad Sci USA 2021, 118 (37), e2022194118. https://doi.org/10.1073/PNAS.2022194118/SUPPL_FILE/PNAS.2022194118.SAPP.P DF.
Evans, C. M.; Singh, M. R.; Lynd, N. A.; Segalman, R. A. Lawrence Berkeley National Laboratory Recent Work Title Improving the Gas Barrier Properties of Nafion via Thermal Annealing: Evidence for Diffusion through Hydrophilic Channels and Matrix. 2015. https://doi.org/10.1021/acs.macromol.5b00579.
Gabrielli, P.; Gazzani, M.; Mazzotti, M. The Role of Carbon Capture and Utilization, Carbon Capture and Storage, and Biomass to Enable a Net-Zero-CO 2 Emissions Chemical Industry. 2020. https://doi.org/10.1021/acs.iecr.9b06579.
Tao, H.; Qian, X.; Zhou, Y.; Cheng, H. Research Progress of Clay Minerals in Carbon Dioxide Capture. Renewable and Sustainable Energy Reviews 2022, 164. https://doi.org/10.1016/J.RSER.2022.112536.
Zhu, P.; Tavassoli, S.; Ryu, J.; Pyrcz, M.; Balhoff, M. T. Injection of Gel Systems for CO2 Leakage Remediation in a Fractured Reservoir. International Journal of Oil, Gas and Coal Technology 2022, 29 (1), 52-74. https://doi.org/10.1504/IJOGCT.2022.119340.
Modak, A.; Jana, S. Advancement in Porous Adsorbents for Post-Combustion CO2 Capture. Microporous and Mesoporous Materials 2019, 276, 107-132. https://doi.org/10.1016/J.MICROMESO.2018.09.018.
Tao, H.; Qian, X.; Zhou, Y.; Cheng, H. Research Progress of Clay Minerals in Carbon Dioxide Capture. Renewable and Sustainable Energy Reviews 2022, 164, 112536. https://doi.org/10.1016/J.RSER.2022.112536.
Lan, Y.; Liu, Y.; Li, J.; Chen, D.; He, G.; Parkin, P. I. Natural Clay-Base Materials for Energy Storage and Conversion Applications. Adv. Sci. 2021, 2020004036. DOI: 10.1002/advs.202004036
Chen, W.; Lei, T.; L v, W.; Yan, Y.; Jiao, Yu.; Li, H. Z.; Yan, C.; Xiong, j. Atomic Interlamellar Ion Path in High Sulfur Content Lithium-Montmorillonite Host Enables High-Rate and Stable Lithium-Sulfur Battery. Adv. Mater. 2018, 30, 1804084. DOI: 10.1002/adma.201804084
Lundquist, J.; Lundsager, C. B.; Palmer, N. I.; Troffkin, H. J. Battery separator—U.S. patent U.S. Pat. No. 4,650,730, Mar. 17, 1987.
Lunchinger, N. A.; Stark, W. J.; Kellenberger, C. R. Porous polymer membranes—International patent WO 2012/097967 A1, Jul. 26, 2012.
Frost, J. C.; David, J.; Sharman, B.; Permogorov, N. M. Ion-Conducting Membrane—U.S. patent US2015/0180073 A1, Jun. 25, 2015.
Kreuer, K. D. Ion conducting Membranes for Fuel Cells and other Electrochemical Devices. Chem. Mater. 2014, 26, 361-380. DOI:https://doi.org/10.1021/cm402742u
Yuan, J.; Pan, Z.; Qui, Q.; Zhang, C.; Zhao, Y.; Li, Y. Membranes in Non-aqueous Redox Flow Battery: A Review. J. Pow. Sour. 2021, 500, 229983. DOI:https://doi.org/10.1016/j.jpowsour.2021.229983.
Lee, S. Eco-Degradable and Flexible Solid-State Ionic Conductors by Clay-Nanoconfined DMSO Composites. Adv. Sustain. Sys. 2020, 4, 1900134. DOI:https://doi.org/10.1002/adsu.201900134.
Young, Edgar D. “SECONDARY BATTERIES WITH TREATED BENTONITE CATHODES HAVING ENHANCED CONDUCTIVITY”. U.S. Pat. No. 8,445,134 B2, United States Patent and Trademark Office, May 21, 2013.

Liu, F.; Chuan, X. Recent Developments in Natural Mineral-Based Separators for Lithium-Ion Batteries RSC Adv. 2021, 11, 16633. DOI:https://doi.org/10.1039/d1ra02845f.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A zwitterion-promoted clay film apparatus, the zwitterion-promoted clay film apparatus comprising:
at least one zwitterion molecule;
at least one bentonite clay molecule;
wherein the at least one bentonite clay molecule comprises at least one clay layer; and
wherein the at least one zwitterion molecule is intercalated within at least one portion of the clay layer.

2. The zwitterion-promoted clay film apparatus of claim 1, wherein the at least one clay layer comprises at least one clay gallery.

3. The zwitterion-promoted clay film apparatus of claim 2, wherein the at least one zwitterion molecule is chemically disposed within at least one portion of the at least one clay gallery, whereby at least one zwitterion moiety is formed.

4. The zwitterion-promoted clay film apparatus of claim 3, wherein the at least one zwitterion moiety comprises a high-carbon derivative of the at least one zwitterion molecule, a low-carbon derivative of the at least one zwitterion molecule, or both.

5. The zwitterion-promoted clay film apparatus of claim 4, wherein the at least one clay layer is smooth, distorted, or both.

6. The zwitterion-promoted clay film apparatus of claim 5, wherein the at least one zwitterion moiety comprises a d-spacing of about 1.4 nm to about 2.2 nm.

7. The zwitterion-promoted clay film apparatus of claim 3, wherein the at least one zwitterion moiety comprises an ionic conductivity.

8. The zwitterion-promoted clay film apparatus of claim 7, wherein the ionic conductivity of the at least one zwitterion moiety is about 10⁻⁴ S/cm to about 10⁻⁵ S/cm.

9. The zwitterion-promoted clay film apparatus of claim 3, wherein the at least one zwitterion moiety is thermally stable, mechanically stable, or both.

10. The zwitterion-promoted clay film apparatus of claim 9, wherein the at least one zwitterion moiety is configured to maintain its formation in a temperature of about 250° C.

11. The zwitterion-promoted clay film apparatus of claim 9, wherein the at least one zwitterion moiety is configured to maintain its formation when placed within strong solvents, the strong solvents selected from a group consisting of tetrahydrofuran (hereinafter “THF”), hexane, acetonitrile, toluene, dichloromethane (hereinafter “DCM”), and a combination of thereof.

12. The zwitterion-promoted clay film apparatus of claim 11, wherein the at least one zwitterion moiety is decomposable in an aqueous solution.

13. A method of synthesizing a zwitterion-promoted clay film apparatus, the method comprising:
pretreating at least one zwitterion molecule, the at least one zwitterion having a predetermined carbon chain length;
intercalating the at least one zwitterion molecule within at least one portion of at least one bentonite clay molecule having at least one clay layer, the at least one clay layer comprising at least one clay galley; and
chemically bonding the at least one zwitterion molecule with at least one portion of the at least one clay galley to form at least one zwitterion moiety.

14. The method of claim 13, further comprising the step of, after chemically bonding the at least one zwitterion molecule with at least one portion of the at least one clay galley, coating the at least one zwitterion moiety upon at least one substrate.

15. The method of claim 13, further comprising the step of, after coating the at least one zwitterion moiety upon the at least one substrate, subsequent to a predetermined drying time, peeling the dried at least one zwitterion moiety off the at least one substrate.

16. The method of claim 15, wherein the predetermined drying time is about 12 hours.

17. The method of claim 16, wherein the at least one zwitterion moiety is dried at a temperature of about 60° C.

18. The method of claim 13, wherein the at least one zwitterion moiety comprises an ionic conductivity.

19. The method of claim 18, wherein the at least one zwitterion moiety is thermally stable, mechanically stable, or both.

20. The method of claim 19, wherein the at least one zwitterion moiety is configured to maintain its formation when placed within strong solvents, the strong solvents selected from a group consisting of tetrahydrofuran (hereinafter “THF”), hexane, acetonitrile, toluene, dichloromethane (hereinafter “DCM”), and a combination of thereof.
